(19) United States
(12) Patent Application Publication
(10) Pub. No.: US 2017/0099863 A1
(43) Pub. Date: Apr. 13, 2017

(54) Rice Cooker/Steamer With Cooler

(71) Applicant: Lyco Manufacturing Inc., Columbus, WI (US)

(72) Inventors: Daniel D. Maupin, Corvallis, OR (US); Steven W. Hughes, Beaver Dam, WI (US); Jeff S. Zittel, Columbus, WI (US); Eric J. Jameson, Lake Mills, WI (US); Steven J. Schultz, Beaver Dam, WI (US)

(73) Assignee: Lyco Manufacturing Inc., Columbus, WI (US)

(21) Appl. No.: 15/213,299

(22) Filed: Jul. 18, 2016

Related U.S. Application Data
(63) Continuation-in-part of application No. 62/193,964, filed on Jul. 17, 2015.

(51) Int. Cl. A23L 7/196; A47J 27/04

(52) U.S. Cl. CPC A23L 7/1965; A47J 27/04; A23V 2002/00; A47J 2027/043

(57) ABSTRACT

A method and apparatus for cooking rice includes a presoak tank a hydrating and cooking tank, and a cooling tank. A first transfer mechanism connected to transfer rice from the pre-soak tank to the hydrating an cooking tank. A second transfer mechanism connected to transfer rice from the hydrating an cooking tank to the cooling tank.

### FIELD OF THE INVENTION

The present disclosure relates generally to the art of rice cooking and rice cookers. More specifically, it relates to rice cookers and cooking rice in large industrial quantities.

### BACKGROUND OF THE INVENTION

Rice is among the most consumed commodity in the world, and processing rice is an old art. Modern large scale processing of rice has leaned toward two processes—batch processing and continuous processing.

Examples of prior art rice cooking include U.S. Pat. Nos. 4,677,907, 4,934,259, 4,873,917, 6,101,926, 6,056,986, 6,035,764, and 5,083,506.

Batch processing is the most common form, and there is much prior art relating to processing rice in batches, from stove-top, to automated home versions, to large scale kitchens. Often, this method of cooking is a full absorption method, where the precise amount of water is added to the cooking batch, and the rice absorbs all the available water, leaving fully cooked, and sticky rice.

But fully absorbed and cooked rice is difficult to handle in a continuous process. Modern food processors, particularly large scale processors, have used a continuous process where the rice is cooked in hot water through a rotary drum unit, or similar device. This method produces a more easily handled product, particularly if the rice is cooled quickly after cooking. However, this method also releases soluble starches into the cooking water which must be exchanged regularly, and these starches cannot be recovered out the water, requiring this water to be sent to a waste treatment source. One prior art continuous rice cooking technique uses steaming belts. Rice can be fully hydrated, and fully cooked on such belts. However, belt units have difficulty in discharging cooked rice, and are difficult to clean, and the rice can be difficult to handle after cooking.

Another prior art techniques is to use a steam auger with a reversing auger to agitate the rice while steaming and cooking the rice. This technique is does use less water. But, this prior art cannot be used for large scale rice cooking, and has other limitations.

Accordingly, a method of cooking rice, using a process close to a fully absorption method, that can produce large industrial capacities of fully hydrated, and fully cooked rice that is relatively easy to handle is desired.

### SUMMARY OF THE PRESENT INVENTION

According to a first aspect of the disclosure a rice cooker includes a presoak tank, a hydrating and cooking tank, and a cooling tank. A transfer mechanism transfers rice from the pre-soak tank to the hydrating an cooking tank. The hydrating and cooking tank is steam filled. A second transfer mechanism transfers rice from the hydrating an cooking tank to the cooling tank.

According to a second aspect of the disclosure a method of continuously cooking rice includes presoaking the rice in a first tank, transferring the rice to a second tank, hydrating and cooking the rice in the second tank using steam, transferring the rice to a cooling tank; and cooling the rice in the cooling tank.

The hydrating and cooking tank includes stirrers in one alternative.

The hydrating and cooking tank includes an inlet for applying water in another alternative.

The hydrating and cooking tank does not include water in one embodiment.

The hydrating and cooking tank and/or the presoak tank includes a rotary drum in various embodiments.

Other principal features and advantages of will become apparent to those skilled in the art upon review of the following drawings, the detailed description and the appended claims.

### BRIEF DESCRIPTION OF THE DRAWINGS

FIG. 1 is diagram of a rice cooking and cooling system; and

FIG. 2 is drum with agitators or stirrers.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present disclosure will be illustrated with reference to a particular embodiment, it should be understood at the outset that the rice cooker and cooler can be implemented with other embodiments.

The preferred embodiment uses a three step process to achieve fully hydrated and cooked rice that is easy to handle. First, the rice is soaked in a continuous pre-soaking process. Preferably, this is in a continuous process using a rotary drum, or similar continuous device, but can be in soak tanks.

Soaking temperature is preferably between ambient water temperature up to 135 degrees F., and more preferably less than 140 degrees F. One preferred embodiment soaks the rice at about 120 degrees F., for 45 minutes. Alternatives provide for soaking from 15 minutes to 2 hours or more Different users may have different requirements, and this can vary with the type of rice being cooked. Proper soaking can increase moisture levels in the rice, such as to 40-70%, or to about 57%.

Starches lost in the continuous pre-soak of the preferred embodiment, particularly at temperatures up to 140 deg F., can more easily be recovered than starches lost in the prior art techniques. Also, the preferred method of a rotary drum pre-soak provides greater hydration consistency than prior art techniques.

The presoak tank can be a tank such as that described in commonly owned U.S. Pat. Nos. 6,205,913; 6,214,400; 6,234,066; 6,263,785; 7,500,426; 7,735,415; 8,006,613; 8,087,348; 8,191,466; 8,839,712; 9,060,530, each of which is incorporated by reference.

After soaking the rice is fully hydrated and fully cooked. The preferred embodiment uses a rotary drum steam cooking unit, at 210 degrees F. for 8-12 minutes. Alternatives provide for using 180 degrees to 240 degrees, and from 5-20 minutes. The rice is sprayed intermittently with small amounts of water, preferably intermittently. One preferred embodiment uses one minute of spray, with two minutes of no spray.

The rotary steam cooker can be a tank such as that described in commonly owned U.S. Pat. Nos. 6,205,913; 6,214,400; 6,234,066; 6,263,785; 7,500,426; 7,735,415; 8,006,613; 8,087,348; 8,191,466; 8,839,712; 9,060,530. The transfer from the presoak tank to the steam tank can be consistent with the prior art, preferably as described in the incorporated patents.

Steam cooking of products other than rice in a rotary drum has been done in the prior art using water and steam. But the preferred embodiment provides that there is no water in the tank and that stirring attachments specifically for rice are provided inside the cylinder to keep the rice separated. The intermittent sprays outside the drum provide lubrication of the cylinder to prevent product damage, and provide enough water for final hydration, without excessive water which makes the rice sticky, and unusable. The stirring attachments can be flat, curved, or other protrusions that stir the rice. They can be fixed in position relative to the drum or the flights of the auger, and/or move relative to the flights of the auger.

Following cooking a quick cooling process is used to separate rice particles. This is preferably performed rapidly after cooking, to reduce the tendency of rice to stick together in large clumps. The preferred embodiment provides for passing through a quenching stage to separate the rice particles and stop the cooking process, then through additional cooling stages as the customer requires. This is preferably performed in a Lyco EZ-Flow® cooling system, or that described in U.S. Pat. No. 7,500,426, or any of the other incorporated patents.

Quick separation of rice particles in addition to quench cooling allows easy handling of the rice after cooking.

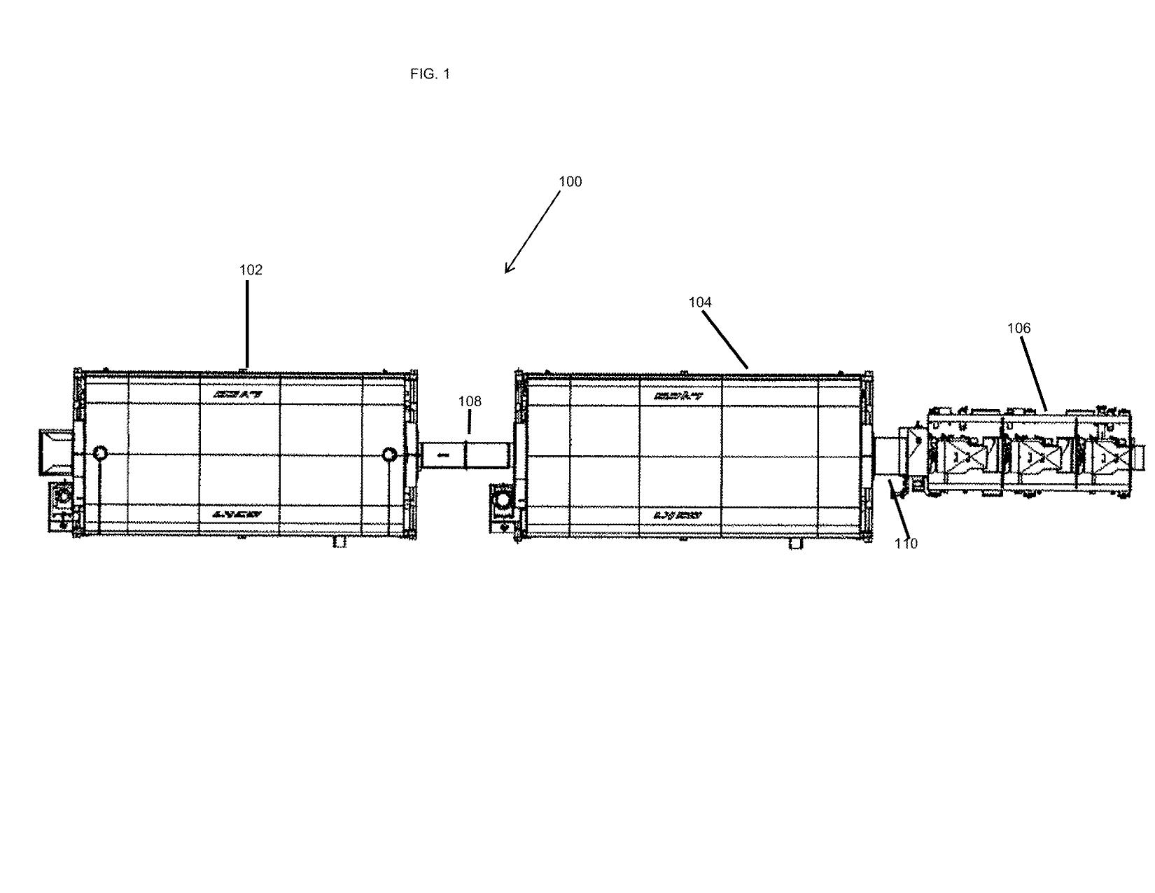

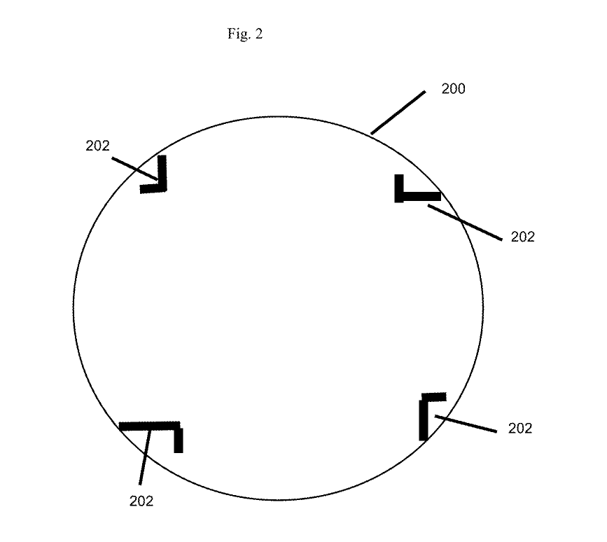

FIG. 1 shows a cooking and cooling system 100 in accordance with the preferred embodiment. A pre-soak tank 102 is a Lyco® rotary blancher. A hydrater/cooker 104 is also a Lyco® rotary blancher, but modified as shown in FIG. 2 so that a drum 200 has stirrers 202 mounted thereon.

Stirrers 202 help agitate the rice prevent clumping, and are either mounted to drum 200 or carried by at least one of the auger flights 50. Stirrers 202 can physically contact the rice. In a preferred embodiment shown stirrer 202 comprises a plate that extends between adjacent auger flights. Preferably, each stirrer 202 forms an acute vee with the drum sidewall that has its apex pointed in the direction of rotation of the drum 52. Preferably, there are between one and four circumferentially spaced apart stirrers 202 between each pair of adjacent auger flights. In the preferred embodiment shown, each stirrer is of substantially flat construction. In another preferred embodiment, the stirrer is of non-straight construction and preferably is curved. If desired, the stirrer can further comprise bars or posts that extend outwardly from the plate. Stirrers 202 orbit the center of the drum as the drum rotates.

A cooling tank 106 is a Lyco EZ-Flow® cooling system, or that described in U.S. Pat. No. 7,500,426. Transfers between tanks is accomplished by transfer mechanisms 108 and 110, and can be found in the prior art.

Numerous modifications may be made to the present disclosure which still fall within the intended scope hereof. Thus, it should be apparent that there has been provided a method and apparatus for cooking and cooling rice that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

The embodiments of the invention in which an exclusive property or privilege is claimed are defined as follows:

1. A rice cooker comprising:
a presoak tank;
a hydrating and cooking tank, wherein the hydrating and cooking tanks is steam filled;
a first transfer mechanism connected to transfer rice from the pre-soak tank to the hydrating an cooking tank;
a cooling tank; and
a second transfer mechanism connected to transfer rice from the hydrating an cooking tank to the cooling tank.

2. The rice cooker of claim 1, wherein the hydrating and cooking tank includes stirrers.

3. The rice cooker of claim 2, wherein the hydrating and cooking tank includes an inlet for applying water.

4. The rice cooker of claim 3, wherein the hydrating and cooking tank does not include water.

5. The rice cooker of claim 1, wherein the hydrating and cooking tank is a rotary drum blancher.

6. The rice cooker of claim 5, wherein the presoak tank includes a rotary drum.

7. A method of continuously cooking rice, comprising:
presoaking the rice in a first tank;
transferring the rice to a second tank;
hydrating and cooking the rice in the second tank using steam;
transferring the rice to a cooling tank; and
cooling the rice in the cooling tank.

8. The method of claim 7, further comprising stirring the rice in the second tank.

9. The method of claim 8, further comprising intermittently applying water to the rice in the second tank.

10. The method of claim 9 wherein the rice is moved in the first tank by turning a drum having an auger therein.

11. The method of claim 10 wherein the rice is moved in the second tank by turning a drum having an auger therein.
